(19) United States
(12) Patent Application Publication
(10) Pub. No.: US 2016/0191884 A1
(43) Pub. Date: Jun. 30, 2016

(54) IMAGE PLAYBACK METHOD AND IMAGE SURVEILLANCE SYSTEM THEREOF

(71) Applicant: VIVOTEK INC., New Taipei City (TW)

(72) Inventors: Chea-Ping Chen, New Taipei City (TW); Shih-Wu FanJiang, New Taipei City (TW)

(21) Appl. No.: 14/955,047

(22) Filed: Dec. 1, 2015

(30) Foreign Application Priority Data
Dec. 25, 2014 (TW) 103145539

(51) Int. Cl. H04N 9/87; G06K 9/00; H04N 5/915; H04N 5/77; H04N 5/247; H04N 7/18

(52) U.S. Cl. CPC H04N 9/87; H04N 5/247; H04N 7/181; H04N 5/915; H04N 5/77; G06K 9/00771

(57) ABSTRACT

An image playback method is applied to an image surveillance system. The image surveillance system includes a plurality of image capturing devices and a display monitor. The image playback method includes receiving image data captured by each image capturing device, setting a first score of each image data according to a content of each image data, setting a second score of each image data according to a geographical location where each image capturing device captures the image data, and performing selective playback of each image data on the display monitor according to the first score and the second score of each image data.

### BACKGROUND OF THE INVENTION

1. Field of the Invention

The present invention relates to an image playback method and an image surveillance system thereof, and more specifically, to an image playback method for setting a first score and a second score of image data according to a content of the image data and a geographical location where an image capturing device captures the image data and performing selective of the image data on a display monitor and an image surveillance system thereof.

2. Description of the Prior Art

In general, a conventional image surveillance system usually has a plurality of image capturing devices and performs playback of images captured by each image capturing device on a display monitor simultaneously or sequentially for monitoring plural locations (e.g. an entrance of a lobby or a parking lot) in real time. However, if the images captured by each image capturing device are displayed on the display monitor at the same time, it is inconvenient for a user to view each image clearly since the overcrowded images are displayed on one single display monitor. Although the aforesaid problem could be solved by sequentially displaying each image on the display monitor, it may further cause another problem that the user may miss to view the images of high importance easily.

### SUMMARY OF THE INVENTION

The present invention provides an image playback method applied to an image surveillance system. The image surveillance system includes a plurality of image capturing devices and at least one display monitor. The image playback method includes receiving image data captured by each image capturing device, setting a first score of each image data according to a content of each image data, setting a second score of each image data according to a geographical location where each image capturing device captures the image data, and performing selective playback of each image data on the at least one display monitor according to the first score and the second score of each image data.

The present invention further provides an image surveillance system. The image surveillance system includes a plurality of image capturing devices for capturing image data, at least one display monitor, and a processing unit. The at least one display monitor is used for performing selective playback of each image data. The processing device is electrically connected to the plurality of image capturing devices and the at least one display monitor, for setting a first score of each image data according to a content of each image data, setting a second score of each image data according to a geographical location where each image capturing device captures the image data, and controlling the at least one display monitor to perform selective playback of each image data according to the first score and the second score of each image data.

The present invention further provides an image surveillance system. The image surveillance system includes a plurality of image capturing devices, at least one display monitor, at least one processing unit, and a playback control unit. The plurality of image capturing devices is used for capturing image data. The at least one display monitor is used for performing selective playback of each image data. The at least one processing unit is disposed in at least one of the plurality of image capturing devices. The playback control unit is electrically connected to the at least one processing unit and the at least one display monitor. The at least one processing unit and the playback control unit are used for setting a first score of each image data according to a content of each image data, setting a second score of each image data according to a geographical location where each image capturing device captures the image data, and controlling the at least one display monitor to perform selective playback of each image data according to the first score and the second score of each image data.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a functional block diagram of an image surveillance system according to an embodiment of the present invention.

FIG. 2 is a flowchart of an image playback method according to an embodiment of the present invention.

FIG. 3 is a diagram of a display monitor in FIG. 1 performing playback of image data selected by a playback control unit.

### DETAILED DESCRIPTION

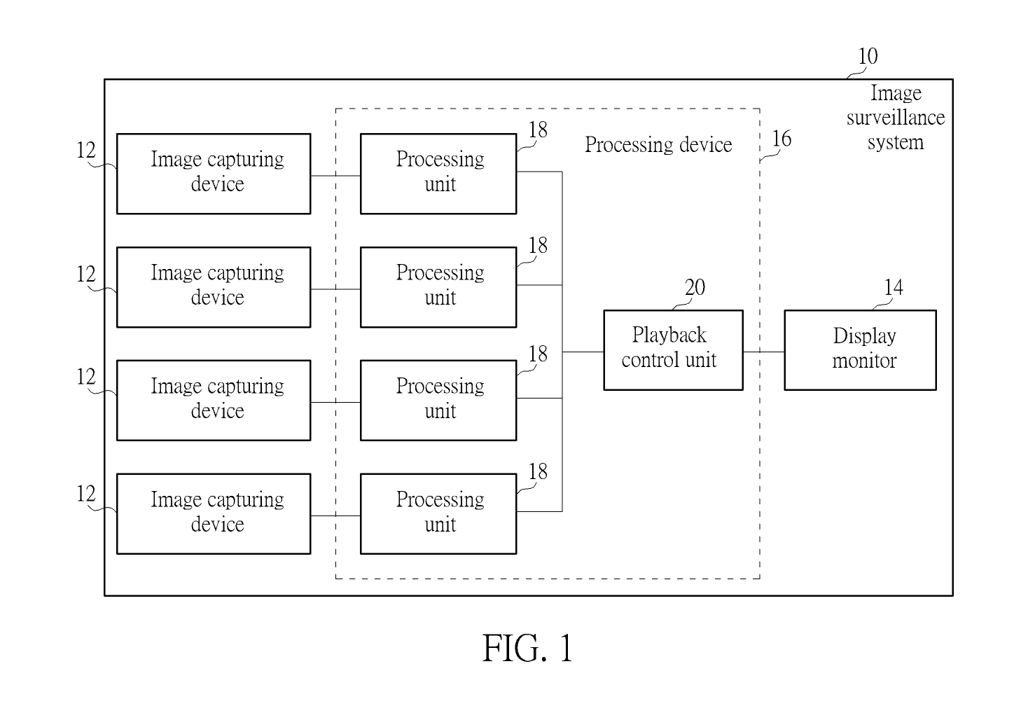

Please refer to FIG. 1, which is a functional block diagram of an image surveillance system 10 according to an embodiment of the present invention. As shown in FIG. 1, the image surveillance system 10 includes a plurality of image capturing devices 12 (four shown in FIG. 1, but not limited thereto), at least one display monitor 14 (one shown in FIG. 1, but not limited thereto, meaning that the present invention could utilize plural display monitors 14 to perform selective playback of image data captured by each image capturing device 12), and a processing device 16. Each image capturing device 12 could be preferably a security camera (e.g. an IP camera) for image surveillance. The display monitor 14 is used for performing playback of the image data captured by each image capturing device 12. In this embodiment, the processing device 16 could include a plurality of processing units 18 (four shown in FIG. 1, but not limited thereto) and a playback control unit 20. The plurality of processing units 18 is disposed in the plurality of image capturing devices 12 respectively. Each processing unit 18 could be used for setting a first score and a second score of each image data according to a content of each image data and a geographical location where each image capturing device 12 captures the image data. The playback control unit 20 is electrically connected to the plurality of processing units 18 and the display monitor 14 for controlling the display monitor 14 to perform selective playback of each image data according to the first score and the second score of each image data.

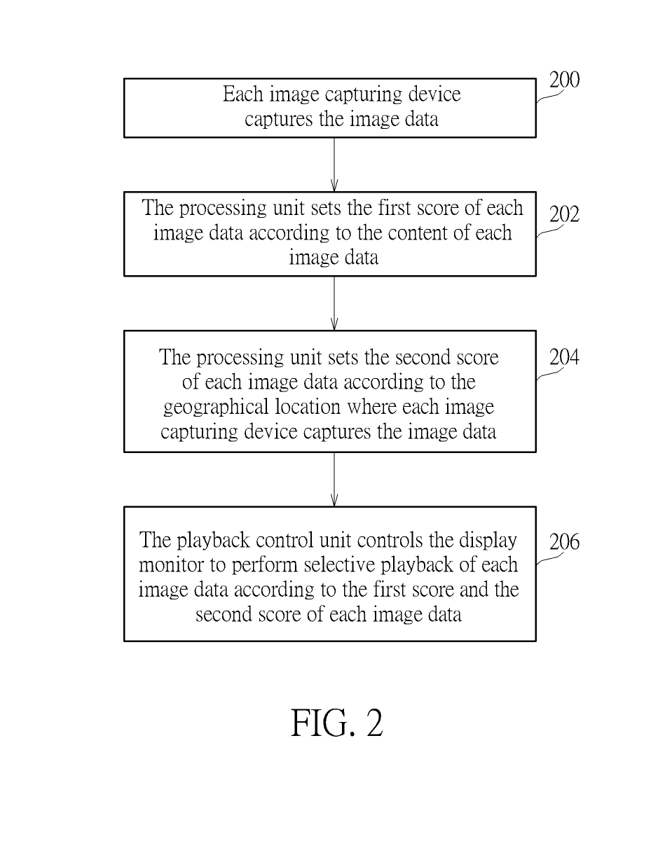

Please refer to FIG. 1 and FIG. 2. FIG. 2 is a flowchart of an image playback method according to an embodiment of the present invention. The image playback method of the present invention includes the following steps.

Step 200: Each image capturing device 12 captures the image data.

Step 202: The processing unit 18 sets the first score of each image data according to the content of each image data.

Step 204: The processing unit 18 sets the second score of each image data according to the geographical location where each image capturing device 12 captures the image data.

Step 206: The playback control unit 20 controls the display monitor 14 to perform selective playback of each image data according to the first score and the second score of each image data.

More detailed description for the aforesaid steps is provided as follows. In Step 200, the image surveillance system 10 could control each image capturing device 12 to capture the image data. Subsequently, the processing unit 18 could set the first score of each image data according to the content of the image data captured by each image capturing device 12 (Step 202), such as a file size, an image identification result, or an image event analysis result of each image data (but not limited thereto).

For example, in practical application, since the processing unit 18 could obtain file sizes of an intra-frame (I-frame) and a plurality of predicted-frames (P-frames) in each GOP (Group of Pictures) of each image data according to header information of image packets in each image data, the processing unit 18 could score each image data according to the file sizes of the intra-frame and the plurality of predicted-frames. In practical application, since the file sizes of the predicted-frames in the GOPs having different resolutions are different from each other in the same image capturing condition, the processing unit 18 could perform a normalization process on the file sizes of the intra-frame and the plurality of predicted-frames in each GOP of each image data in this embodiment. For example, the processing unit 18 could calculate the P-frame average size P of the predicted-frames of each GOP, and could calculate a ratio of the I-frame size I of the intra-frame to the P-frame average size P (i.e. I/P) or a ratio of the P-frame average size P to the I-frame size I (i.e. P/I), so that the processing unit 18 could score each image data according to the corresponding ratio.

Furthermore, the processing unit 18 could utilize a conventional image identification method to determine the importance of each image data. For example, the processing unit 18 could utilize an image contour identification method to calculate number of people of each group in the image data, so that the processing unit 18 could determine the image data with the group having more people as the image data of high importance and increase the score of this image data accordingly. As for the related description for the principle of the image identification method utilized by the present invention, it is commonly seen in the prior art and omitted herein.

Furthermore, the processing unit 18 could utilize a conventional image event analysis method (e.g. VCA (Video Content Analysis) or IVA (Intelligent Video Analysis)) to score each image data. For example, the processing unit 18 could determine the importance of each image data according to whether an image event occurs in each image data (e.g. whether a running man, a speeding vehicle, or a specific color is detected), a duration of the image event, an occurrence frequency of the image event, and an occurrence number of the image event. Accordingly, the processing unit 18 could determine the image data having the predetermined important image event as the image data of high importance and increase the score of this image data accordingly.

After the processing unit 18 has set the first score of each image data according to the aforesaid content of each image data, the processing unit 18 could set the second score of each image data according to the geographical location where each image capturing device 12 captures the image data (Step 204). For example, the processing unit 18 could determine the importance of each image data according to the location (e.g. an entrance of a lobby or a parking lot) monitored by each image capturing device 12, so that the processing unit 18 could determine the image data corresponding to the important surveillance location (predetermined by the image surveillance system 10 or defined by the user) as the image data of high importance and increase the score of this image data accordingly.

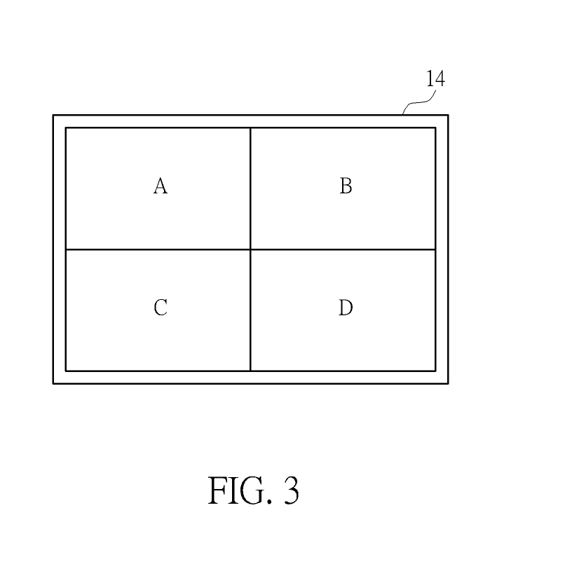

Please refer to FIG. 3, which is a diagram of the display monitor 14 in FIG. 1 performing playback of the image data selected by the playback control unit 20. As shown in FIG. 3, the playback control unit 20 could control the display monitor 14 to perform selective playback of each image data according to the aforesaid first and second scores (Step 206). To be more specific, in this embodiment, the playback control unit 20 could calculate the aforesaid first and second scores (e.g. by adding, multiplying, or averaging) to generate the corresponding composite scores, and then could record these composite scores in a renewable table (e.g. Table 1 below, in which the composite scores are generated by adding the first and second scores respectively, but not limited thereto). Accordingly, the playback control unit 20 could select the image data having the higher composite scores from Table 1 (but not limited thereto, meaning that the playback control unit 20 could select the image data having the composite scores higher than a specific score), such as the image data captured by the image capturing devices of No. 2, 3, 4, and 5, and then could control the display monitor 14 to perform playback of the selected image data simultaneously (e.g. in four split-screens A, B, C, and D on the display monitor 14 as shown in FIG. 3). The amount of the image data selected by the playback control unit 20 is not limited to four as shown in FIG. 3, but could vary with the amount of the split-screens of the display monitor 14. To be noted, in practical application, the playback control unit 20 could periodically select the image data having the higher composite scores from the renewable Table 1 at a predetermined period of time (e.g. 15 seconds, which is predetermined by the image surveillance system 10 or defined by the user), and then could control the display monitor 14 to perform playback of the following selected image data. In such a manner, the present invention not only solves the prior art problem that the user may miss to view the image data of high importance accidentally due to the quick refresh rate of the image data, but also ensures that the user could view the image data of high importance in real time by the aforesaid image playback method.

TABLE 1

| No. | 1 | 2 | 3 | 4 | 5 | 6 | 7 | 8 |
|---|---|---|---|---|---|---|---|---|
| First score | 48 | 84 | 65 | 56 | 99 | 2 | 19 | 17 |
| Second score | 45 | 52 | 68 | 95 | 69 | 77 | 6 | 11 |
| Composite score | 92 | 136 | 133 | 152 | 168 | 79 | 24 | 27 |

It should be mentioned that the image playback method of the present invention could further include the step of setting a time weight of each image data. That is, the processing unit 18 could set the time weight of each image data according to when each image data is captured and the geographical location of each image capturing device 12. For example, the processing unit 18 could determine the image data captured at lunch by the image capturing device monitoring the restaurant as the image data of a higher time weight. Accordingly, the processing unit 18 could calculate the first and second scores and the time weight of each image data (e.g. by adding the first score and the product of the second score and the time weight) to generate the corresponding composite score of each image data, and the playback control unit 20 could accordingly control the display monitor 14 to perform playback of the image data having high composite scores. In such a manner, the present invention could further improve accuracy of the image surveillance system 10 in determining the importance of the image data and meet the practical surveillance needs.

Furthermore, the design of the processing device 16 is not limited to the aforesaid embodiment, meaning that the present invention could adopt the design that the playback control unit 20 could be used for scoring some image data. For example, in the embodiment in which only some image capturing devices 12 have the processing units 18 disposed therein while the other image capturing devices 12 are only coupled to the playback control units 20, the image capturing device 12 having the processing unit 18 disposed therein could directly score the image data according to the content of the image data and the geographical location where the image capturing device 12 captures the image data, and then could transmit the first and second scores of the image data to the playback control unit 20. On the other hand, the image capturing device 12 without the processing unit 18 could directly transmit the image data to the playback control unit 20, so that the playback control unit 20 could score the image data by itself according to the content of the image data and the geographical location where the image capturing device 12 captures the image data. After the first and second scores of each image data are set, the playback control unit 20 could control the display monitor 14 to perform selective playback of each image data according to the first and second scores of each image data.

Compared with the prior art in which the image data captured by each image capturing device is displayed on the display monitor simultaneously or sequentially, the present invention adopts the image playback method in which the first and second scores of each image data are set according to the content of each image data and the geographical location where each image capturing device captures the image data and selective playback of each image data is performed according to the first and second scores of each image data. In such a manner, the present invention efficiently solves the prior art problem that it is inconvenient for the user to view the overcrowded images on one single display monitor clearly and the user may miss to view the image data of high importance easily due to the quick refresh rate of the image data, so as to ensure that the user could view the image data of high importance in real time. Thus, the practicality of the image surveillance system in image surveillance could be greatly improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An image playback method applied to an image surveillance system, the image surveillance system comprising a plurality of image capturing devices and at least one display monitor, the image playback method comprising:
receiving image data captured by each image capturing device;
setting a first score of each image data according to a content of each image data;
setting a second score of each image data according to a geographical location where each image capturing device captures the image data; and
performing selective playback of each image data on the at least one display monitor according to the first score and the second score of each image data.

2. The image playback method of claim 1, wherein setting the first score of each image data according to the content of each image data comprises:
setting the first score of each image data according to at least one of a file size, an image identification result, and an image event analysis result of each image data.

3. The image playback method of claim 2, wherein a GOP (Group of Pictures) of each image data comprises an intra-frame (I-frame) and a plurality of predicted-frames (P-frames), and setting the first score of each image data according to the file size of each image data comprises:
setting the first score of each image data according to file sizes of the intra-frame and the plurality of predicted-frames.

4. The image playback method of claim 3, wherein setting the first score of each image data according to the file sizes of the intra-frame and the plurality of predicted-frames comprises:
calculating a P-frame average size of each GOP;
calculating a ratio of an I-frame size and the P-frame average size of each GOP; and
setting the first score of each image data according to the ratio of each GOP.

5. The image playback method of claim 2, wherein setting the first score of each image data according to the image event analysis result of each image data comprises:
setting the first score of each image data according to at least one of whether an image event occurs in each image data, a duration of the image event, an occurrence frequency of the image event, and an occurrence number of the image event.

6. The image playback method of claim 1 further comprising:
setting a time weight of each image data according to when each image data is captured;
wherein selective playback of each image data on the at least one display monitor is performed according to the first score, the second score, and the time weight of each image data.

7. An image surveillance system comprising:
a plurality of image capturing devices for capturing image data;
at least one display monitor for performing selective playback of each image data; and
a processing device electrically connected to the plurality of image capturing devices and the at least one display monitor, for setting a first score of each image data according to a content of each image data, setting a second score of each image data according to a geographical location where each image capturing device captures the image data, and controlling the at least one display monitor to perform selective playback of each image data according to the first score and the second score of each image data.

8. The image surveillance system of claim 7, wherein the processing device is used for setting the first score of each image data according to at least one of a file size, an image identification result, and an image event analysis result of each image data.

9. The image surveillance system of claim 8, wherein a GOP (Group of Pictures) of each image data comprises an intra-frame and a plurality of predicted-frames, and the processing device is used for setting the first score of each image data according to file sizes of the intra-frame and the plurality of predicted-frames.

10. The image surveillance system of claim 9, wherein the processing device is used for calculating a P-frame average size of each GOP, calculating a ratio of an I-frame size and the P-frame average size of each GOP, and setting the first score of each image data according to the ratio of each GOP.

11. The image surveillance system of claim 8, wherein the processing device is used for setting the first score of each image data according to at least one of whether an image event occurs in each image data, a duration of the image event, an occurrence frequency of the image event, and an occurrence number of the image event.

12. The image surveillance system of claim 7, wherein the processing device is used for setting a time weight of each image data according to when each image data is captured and controlling the at least one display monitor to perform selective playback of each image data according to the first score, the second score, and the time weight of each image data.

13. An image surveillance system comprising:
a plurality of image capturing devices for capturing image data;
at least one display monitor for performing selective playback of each image data;
at least one processing unit disposed in at least one of the plurality of image capturing devices; and
a playback control unit electrically connected to the at least one processing unit and the at least one display monitor, the at least one processing unit and the playback control unit being used for setting a first score of each image data according to a content of each image data, setting a second score of each image data according to a geographical location where each image capturing device captures the image data, and controlling the at least one display monitor to perform selective playback of each image data on the at least one display monitor according to the first score and the second score of each image data.

14. The image surveillance system of claim 13, wherein the at least one processing unit and the playback control unit are used for setting the first score of each image data according to at least one of a file size, an image identification result, and an image event analysis result of each image data.

15. The image surveillance system of claim 14, wherein a GOP (Group of Pictures) of each image data comprises an intra-frame and a plurality of predicted-frames, and the at least one processing unit and the playback control unit are used for setting the first score of each image data according to file sizes of the intra-frame and the plurality of predicted-frames.

16. The image surveillance system of claim 15, wherein the at least one processing unit and the playback control unit are used for calculating a P-frame average size of each GOP, calculating a ratio of an I-frame size and the P-frame average size of each GOP, and setting the first score of each image data according to the ratio of each GOP.

17. The image surveillance system of claim 14, wherein the at least one processing unit and the playback control unit are used for setting the first score of each image data according to at least one of whether an image event occurs in each image data, a duration of the image event, an occurrence frequency of the image event, and an occurrence number of the image event.

18. The image surveillance system of claim 13, wherein the at least one processing unit and the playback control unit are used for setting a time weight of each image data according to when each image data is captured and controlling the at least one display monitor to perform selective playback of each image data on the at least one display monitor according to the first score, the second score, and the time weight of each image data.

19. The image surveillance system of claim 13, wherein the at least one processing unit is used for setting the first score and the second score of the image data captured by the at least one of the plurality of image capturing devices according to the content and the geographical location of the image data.

20. The image surveillance system of claim 13, wherein the playback control unit is used for controlling the at least one display monitor to perform selective playback of each image data according to the first score and the second score of each image data.
